(19) United States
(12) Patent Application Publication
(10) Pub. No.: US 2008/0148003 A1
(43) Pub. Date: Jun. 19, 2008

(54) SPATIAL BASED DYNAMIC TRANSCEIVER ADJUSTMENT

(76) Inventors: Mark A. Brandyberry, Austin, TX (US); Daniel N. de Araujo, Cedar Park, TX (US); Nickolaus J. Gruendler, Manor, TX (US); Nam Huu Pham, Round Rock, TX (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(21) Appl. No.: 11/612,658

(22) Filed: Dec. 19, 2006

(51) Int. Cl. G06F 12/00

(52) U.S. Cl. 711/170; 711/E12.001

(57) ABSTRACT

Embodiments of the invention address deficiencies of the art in respect to parameter value configuration for signaling in a multi-drop net, and provide a novel and non-obvious method, system and apparatus for spatial based transceiver adjustment. In one embodiment of the invention, a spatial based dynamic transceiver configuration method can be provided for a multi-drop net. The method can include locating a position for a target receiver for signaling in the multi-drop net, selecting a static transceiver configuration corresponding to the position, and signaling the target receiver utilizing the selected static transceiver configuration. The locating, selecting and signaling can be repeated for different target receivers in different positions in the multi-drop net each repetition utilizing a different selected transceiver configuration.

### BACKGROUND OF THE INVENTION

1. Field of the Invention

The present invention relates to the field of transmission line signal integrity and more particularly to transceiver adjustment for optimal transmission line signaling.

2. Description of the Related Art

Signal integrity refers to the recognition of a signal upon receipt as it was intended during transmission. Historically, in digital systems ensuring signal integrity involved little more than the strategic placement of bypass capacitors during board design and layout. Modern board level components, however, push the frequency envelope resulting in the introduction of traditional transmission line problems previously characteristic only in telecommunications links. In particular, signal integrity has become of paramount concern in the field of memory bus design where bit rates now exceed five-hundred mega-bits per second and where edge rates fall short of just several hundred picoseconds.

In memory bus design, ensuring signal integrity relates to the maximization of the eye or window of good data in a signal. The maximization of the eye involves the minimization of level-related noise affecting the logic level of a signal, coupled with the minimization of time-related noise, or jitter, affecting the position of signal transitions from low to high states and vice-versa. Unchecked, the combination can reduce signal margins in both the time and voltage domains so as to reduce the eye in which good data is available.

The problem of maintaining signal integrity can become compounded when considering electrical signaling across multi-drop nets. In a multi-drop net, multiple component boards can be coupled to one another communicatively across a passive backplane. Classically associated with the placement of memory modules including dual inline memory modules (DIMMs) in a computing architecture, in a multi-drop net, not only must the transfer characteristics for a single memory module be considered from controller to module across the backplane, but also the positioning of the module in the backplane itself. Spatially, the configuration of signaling parameters to ensure a minimization of voltage level and time level noise can vary for the same receiving module depending upon the placement of the module in the bus.

At present, several signaling parameter configurations are known to effect signal integrity in a multi-drop net. In particular, board designers consider position, termination, transceiver strength, equalization, slew rate, and stub lengths. The proper combination of parameter values in a configuration of devices in a multi-drop net are determined experimentally according to a static configuration of receiving devices in the multi-drop net. Of course, as the static configuration of receiving devices varies over time, the optimization achieved by the initial proper combination of parameter values will be lost.

### BRIEF SUMMARY OF THE INVENTION

Embodiments of the invention address deficiencies of the art in respect to parameter value configuration for signaling in a multi-drop net, and provide a novel and non-obvious method, system and apparatus for spatial based transceiver adjustment. In one embodiment of the invention, a spatial based dynamic transceiver configuration method can be provided for a multi-drop net. The method can include locating a position for a target receiver for signaling in the multi-drop net, selecting a static transceiver configuration corresponding to the position, and signaling the target receiver utilizing the selected static transceiver configuration. The locating, selecting and signaling can be repeated for different target receivers in different positions in the multi-drop net each repetition utilizing a different selected transceiver configuration.

In one aspect of the embodiment, the multi-drop net can be a memory bus. To that end, locating a position for a target receiver for signaling in the multi-drop net, can include locating a bus position for a target memory module for receiving a commanded write operation over a memory bus. Additionally, selecting a static transceiver configuration corresponding to the position can include selecting a static pre-configuration of transceiver parameter values for transceiver parameters that can include, for instance, slew rate, driver strength, and equalization. Yet further, signaling the target receiver utilizing the selected static transceiver configuration can include writing data to the target memory module utilizing the selected static transceiver configuration.

In another embodiment of the invention, a computer data processing system incorporating a multi-drop net can be provided. The system can include a central processing unit (CPU) coupled to multiple different buffers/registers. The system also can include a memory controller including a transceiver configured for signaling receivers utilizing a static transceiver configuration. The system yet further can include multiple different memory modules coupled to the memory controller over a memory bus. The system even yet further can include multiple different static transceiver configurations, each including an association with a position in the bus. Finally, the system can include spatial based dynamic transceiver adjustment logic. The logic can include program code enabled to select one of the static transceiver configurations for use by the transceiver when signaling one of the memory modules in a specific position in the bus.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a computing platform configured for spatial based dynamic transceiver adjustment in a multi-drop net; and,

FIG. 2 is a flow chart illustrating a process for spatial based dynamic transceiver adjustment in a multi-drop net.

### DETAILED DESCRIPTION OF THE INVENTION

Embodiments of the invention provide a method, system and computer program product for spatial based dynamic transceiver adjustment in a multi-drop net. In accordance with an embodiment of the present invention, multiple different transceiver configurations can be established for different spatial positions of receiving devices in the multi-drop net. Thereafter, prior to signaling any particular receiving device in the multi-drop net, the spatial position of the receiving device in the multi-drop net can be determined and a corresponding configuration can be selected based upon the spatial position. Thereafter, signaling can commence for the receiving device according to the selected transceiver configuration. The process can repeat for subsequent signaling of over receiving devices in the multi-drop net.

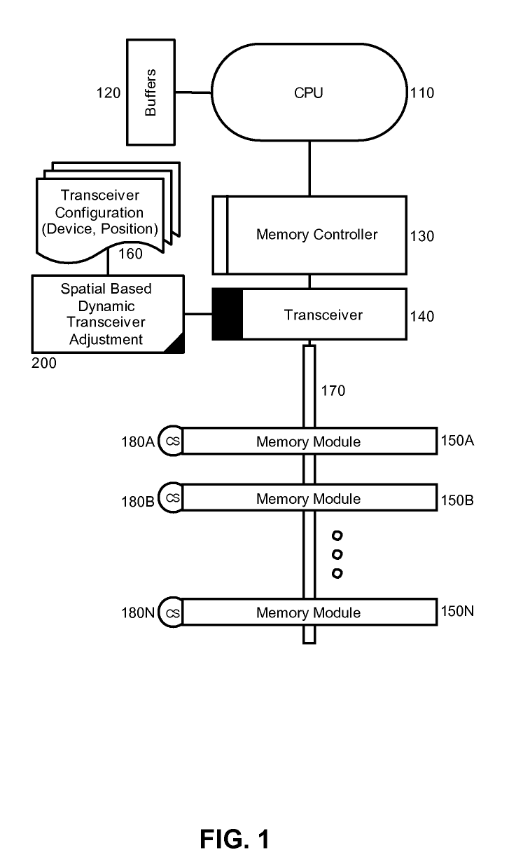

In further illustration, FIG. 1 is a schematic illustration of a computing platform configured for spatial based dynamic transceiver adjustment in a multi-drop net As shown in FIG. 1, the computing platform can include a central processing unit (CPU) 110 coupled to one or more buffers/registers 120. Main memory can include one or more memory modules 150A, 150B, 150N coupled to a memory controller 130/transceiver 140 combination over a memory bus 170. In this regard, executing instructions in the CPU 110 can access data in the memory modules 150A, 150B, 150N by way of the memory controller 130 using the buffers/registers 120 for transient storage of the retrieved data as it is well-known in the art.

Transceiver 140 coupled to the memory controller 130 can physically write data to different ones of the memory modules 150A, 150B, 150N by placing data on the bus 170 and selecting the corresponding one of the chip select 180A, 180B, 180N for the memory modules 150A, 150B, 150N whilst commanding the writing of the data to a specified address in memory. Importantly, the signaling of the data to a particular one of the memory modules 150A, 150B, 150N can be governed according to an established transceiver configuration 160. Unlike past arrangements, however, in the present invention, multiple different transceiver configurations 160 can be established, each being associated with a different position of the memory modules 150A, 150B, 150N in the bus 170.

In particular, spatial based dynamic transceiver adjustment logic 200 can be coupled to the transceiver 140. The spatial based dynamic transceiver adjustment logic 200 can include program code enabled to locate a position of a selected one of the memory modules 150A, 150B, 150N in the bus 170. Once located, the position can be used to select one of the transceiver configurations 160 associated with the position in the bus 170. The transceiver configurations 160 can include parameter values such as slew rate, driver strength and equalization which vary according to the position of a selected one of the memory modules 150A, 150B, 150N in the bus 170.

It is to be noted that the resulting signaling will be optimal for the selected one of the memory modules 150A, 150B, 150N and the others of the modules 150A, 150B, 150N will remain unaffected as only the chip selected for the selected one of the memory modules 150A, 150B, 150N will have been activated. Of course, the program code of the spatial based dynamic transceiver adjustment logic 200 can continue to select different ones of the transceiver configurations 160 for different positions in the bus 170 as different ones of the memory modules 150A, 150B, 150N are selected to receive written data on the bus 170.

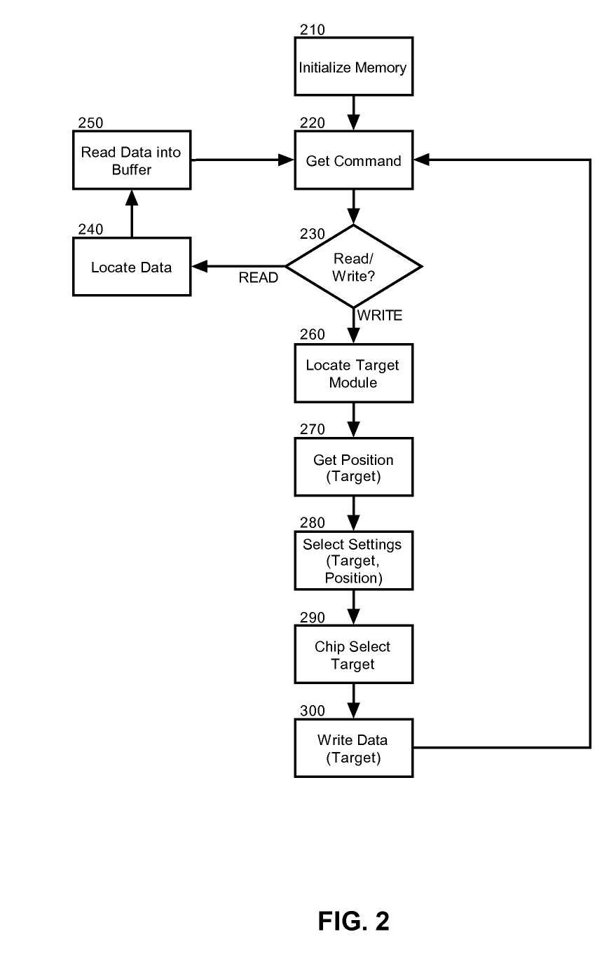

In yet further illustration, FIG. 2 is a flow chart illustrating a process for spatial based dynamic transceiver adjustment in a multi-drop net. Beginning in block 210, memory can be initialized across multiple different memory modules in a bus. In block 220, a command can be received in respect to reading from or writing data to an address in memory associated with a particular one of the memory modules. In decision block 230, if the command is a read command, in block 240 the data can be located among the memory modules and in block 250, the data can be read from the located memory module and the process can continue through block 220.

In decision block 230, however, if a write command is determined to have issued, in block 260 the target memory module to receive the data in the course of the write operation can be located. In block 270, the position of the memory module in the bus can be determined. Notably, in block 280, transceiver configuration settings can be selected according to the spatial position of the memory module in the bus. Thereafter, the transceiver configuration settings can be applied and in block 290 the target memory module can be selected to receive the write operation. Finally, in block 300 the data can be written to the target memory module using signaling applied utilizing the selected transceiver configuration settings.

The embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. In a multi-drop net, a spatial based dynamic transceiver configuration method comprising:
locating a position for a target receiver for signaling in the multi-drop net;
selecting a static transceiver configuration corresponding to the position; and,
signaling the target receiver utilizing the selected static transceiver configuration.

2. The method of claim 1, wherein locating a position for a target receiver for signaling in the multi-drop net, comprises locating a bus position for a target memory module for receiving a commanded write operation over a memory bus.

3. The method of claim 2, wherein selecting a static transceiver configuration corresponding to the position, comprises selecting a static pre-configuration of transceiver parameter values for transceiver parameters selected from the group consisting of slew rate, driver strength, and equalization.

4. The method of claim 2, wherein signaling the target receiver utilizing the selected static transceiver configuration, comprises writing data to the target memory module utilizing the selected static transceiver configuration.

5. The method of claim 1, further comprising performing the locating, selecting and signaling repeatedly for different target receivers in different positions in the multi-drop net each repetition utilizing a different selected transceiver configuration.

6. A computer data processing system incorporating a multi-drop net, the system comprising:
a central processing unit (CPU) coupled to a plurality of buffers;
a memory controller comprising a transceiver configured for signaling receivers utilizing a static transceiver configuration;
a plurality of memory modules coupled to the memory controller over a memory bus;
a plurality of static transceiver configurations, each of the configurations comprising an association with a position in the bus; and,
spatial based dynamic transceiver adjustment logic comprising program code enabled to select one of the static transceiver configurations for use by the transceiver when signaling one of the memory modules in a specific position in the bus.

7. The system of claim 6, wherein the static transceiver configurations each comprises specified values for transceiver configuration parameters selected from the group consisting of slew rate, driver strength and equalization.

8. A computer program product comprising a computer usable medium embodying computer usable program code for spatial based dynamic transceiver configuration in a multi-drop net, the computer program product comprising:
computer usable program code for locating a position for a target receiver for signaling in the multi-drop net;
computer usable program code for selecting a static transceiver configuration corresponding to the position; and,
computer usable program code for signaling the target receiver utilizing the selected static transceiver configuration.

9. The computer program product of claim 8, wherein the computer usable program code for locating a position for a target receiver for signaling in the multi-drop net, comprises computer usable program code for locating a bus position for a target memory module for receiving a commanded write operation over a memory bus.

10. The computer program product of claim 9, wherein the computer usable program code for selecting a static transceiver configuration corresponding to the position, comprises computer usable program code for selecting a static pre-configuration of transceiver parameter values for transceiver parameters selected from the group consisting of slew rate, driver strength, and equalization.

11. The computer program product of claim 9, wherein the computer usable program code for signaling the target receiver utilizing the selected static transceiver configuration, comprises computer usable program code for writing data to the target memory module utilizing the selected static transceiver configuration.

12. The computer program product of claim 8, further comprising computer usable program code for performing the locating, selecting and signaling repeatedly for different target receivers in different positions in the multi-drop net each repetition utilizing a different selected transceiver configuration.
